(19) United States
(12) Patent Application Publication
(10) Pub. No.: US 2010/0000209 A1
(43) Pub. Date: Jan. 7, 2010

(54) Hydraulic control system in working machine ( as amended

(75) Inventors: Atsushi Wada, Hyogo (JP); Naoyuki Moriya, Hyougo (JP); John R. Gay, Raleigh, NC (US); Katsuharu Gonmori, Hyougo (JP)

Correspondence Address: OLIFF & BERRIDGE, PLC, P.O. BOX 320850, ALEXANDRIA, VA, 22320-4850, US

(73) Assignee: CATERPILLAR JAPAN LTD.

(21) Appl. No.: 12/308,665

(22) PCT Filed: Apr. 2, 2007
(86) PCT No.: PCT/JP2007/057403

§ 371 Date: Mar. 11, 2009

(30) Foreign Application Priority Data
Jul. 10, 2006 (JP) 2006-188817

(51) Int. Cl. F15B 1/02; F15B 13/04

(52) U.S. Cl. 60/413; 60/428

(57) ABSTRACT

A hydraulic control system in a working machine includes hydraulic cylinders that make a working part ascend and descend; a first main pump that suctions oil from an oil tank and discharges the oil; an accumulator that accumulates oil discharged from weight holding side oil chambers of the hydraulic cylinders when the working part descends; and a hybrid pump that suctions accumulated oil pressure in the accumulator and discharges the oil pressure. When the working part ascends, discharged oil from the hybrid pump is supplied to the weight holding side oil chambers of the hydraulic cylinders. When an insufficient supply flow from the hybrid pump to the hydraulic cylinders exists, a complementary flow corresponding to the insufficient supply flow is supplied from the first main pump to the weight holding side oil chambers of the hydraulic cylinders.

### CROSS-REFERENCE TO RELATED APPLICATION

This application is the U.S. National Phase of PCT/JP2007/057403, filed Apr. 2, 2007, which claims priority from JP2006-188817, filed Jul. 10, 2006, the entire disclosure of which is incorporated herein by reference hereto.

### BACKGROUND

The present invention relates to a hydraulic control system in a working machine.

There exists a working machine such as a hydraulic shovel or crane that comprises a working part that is capable of moving upward and downward. The working part moves upward and downward based on the extending and contracting operations of hydraulic cylinders to which oil pressure is supplied from a hydraulic pump.

In order to prevent a sudden fall of the working part under its own weight, oil that is discharged to an oil tank from an oil chamber at a weight-holding side of the hydraulic cylinders when a working part moves downward is under a meter-out control by a throttle. The throttle is provided in a control valve that controls an oil supply and discharge of the hydraulic cylinders. The working part, as being positioned above ground level, has a positional energy. Passing through the throttle of the control valve, the positional energy is converted into thermal energy. The thermal energy is emitted eventually into the atmosphere via an oil cooler out of the working machine. In other words, there occurs an energy loss.

In order to solve the problem, there exists a device for a working machine having an auxiliary hydraulic cylinder (an assistance cylinder) as well as regular hydraulic cylinders so as to recover and reuse the positional energy of the working part. When the working part descends, the discharged oil from the weight holding side oil chambers of the auxiliary hydraulic cylinder is accumulated in an accumulator. When the working part ascends, the accumulated oil pressure in the accumulator is supplied to the weight holding side of the auxiliary hydraulic cylinder (for example, see Japanese Patent Number JP-B2-2582310).

### SUMMARY

In the above-mentioned device, although the discharged oil from the auxiliary hydraulic cylinder is accumulated in the accumulator when the working part descends, oil that is discharged from the regular hydraulic cylinders, which are provided to make the working part ascend and descend, is discharged to the oil tank via the control valves. As a result, only part of the positional energy of the working part can be recovered.

Furthermore, if oil pressure is not sufficiently accumulated in the accumulator when the working part ascends, then oil pressure that is supplied from the hydraulic pump to the regular cylinders via the control valve is partially supplied to the auxiliary hydraulic cylinder and utilized for accumulations in the accumulator. As a result, an ascending speed of the working part is lowered, and a working efficiency is thus deteriorated.

In order to solve those problems, there exists a proposed mechanism having no auxiliary hydraulic cylinders, wherein oil discharged from the regular hydraulic cylinders when the working part descends is accumulated in the accumulator. The accumulated oil pressure in the accumulator is supplied to the hydraulic cylinders when the working part ascends. However, the oil pressure may not be supplied sufficiently to the hydraulic cylinders due to accumulations in the accumulator. If an oil pressure supply flow to the hydraulic cylinders depends on accumulations in the accumulator, then an ascending speed of the working part cannot be accurately controlled. The workability thus remains unimproved.

In view of the above-described circumstances, the present invention was made for solving the above-mentioned problems as well as other problems. A first aspect of the invention provides a hydraulic control system for a working machine that includes hydraulic cylinders that make a working part ascend and descend; a first main pump that suctions oil from an oil tank and discharges the oil; an accumulator that accumulates oil that is discharged from weight holding side oil chambers of the hydraulic cylinders when the working part descends; and a hybrid pump that suctions accumulated oil pressure in the accumulator and discharges the oil pressure. When the working part ascends, discharged oil from the hybrid pump is supplied to the weight holding side oil chambers of the hydraulic cylinders. When an insufficient supply flow from the hybrid pump to the hydraulic cylinders exists, a complementary flow corresponding to the insufficient supply flow is supplied from the first main pump to the weight holding side oil chambers of the hydraulic cylinders.

According to this construction, when the working part descends, the discharged oil from the weight holding side oil chambers of the hydraulic cylinders is accumulated in the accumulator. When the working part ascends, the oil pressure from the hybrid pump, which suctions the accumulated oil pressure in the accumulator and discharges the oil pressure, is supplied to the weight holding side oil chambers of the hydraulic cylinders. When a supply flow is insufficient from the hydraulic pump, then oil pressure is supplied from the first main pump. Independently of accumulations in the accumulator, oil pressure can be supplied to the weight holding side oil chambers of the hydraulic cylinders. A differential pressure is small between a suction side and a discharge side of the hybrid pump because the hybrid pump suctions and discharges high-oil pressure accumulated in the accumulator. The oil pressure can be supplied with less power being required. A positional energy that is recovered in the accumulator when the working part descends can be reused when the working part ascends. This can also contribute greatly to energy savings.

A second aspect of the invention provides the hydraulic control system for a working machine according to the first aspect that further includes a second main pump that suctions oil from the oil tank and discharges the oil. When the working part ascends, a supply flow from the second main pump flows together with a supply flow from each of the hybrid pump and the first main pump so as to be supplied to the weight holding side oil chambers of the hydraulic cylinders.

According to this construction, there is no possibility that a working part speed is lowered when the working part ascends in a direction against the weight load. This thus improves working efficiency.

A third aspect of the invention provides the hydraulic control system for a working machine according to the first or second aspect that further includes an accumulation detector that detects accumulations in the accumulator. A supply flow from the hybrid pump to the hydraulic cylinders is controlled to either increase or decrease based on an increase or decrease in the accumulations of the accumulator. A supply flow from the first main pump to the hydraulic cylinders is controlled to increase as the supply flow from the hybrid pump to the hydraulic cylinders decreases.

According to this construction, a supply flow from the hybrid pump as well as a supply flow from the first main pump that makes up for an insufficient supply flow of the hybrid pump can be supplied to the hydraulic cylinders in a well-balanced manner according to accumulations in the accumulator.

Excellent operability is also achieved. It is because a failure does not exists that disrupts a smooth operation of the working part while an oil pressure supply is shifted between the hybrid pump and the first main pump. As is often the case with a conventional construction, when the working part ascends, the oil pressure is supplied only from the hybrid pump until the accumulator is empty, and then the oil pressure is shifted so to be supplied from the first main pump once the accumulator is empty.

A fourth aspect of the invention provides the hydraulic control system for a working machine according to the first, second, or third aspect that further includes a first control valve that controls a supply flow from the first main pump to the hydraulic cylinders; and a second control valve that controls a supply flow from the hybrid pump to the hydraulic cylinders.

According to this construction, supply flows can be controlled accurately from both the first main pump and the hybrid pump to boom cylinders.

A fifth aspect of the invention provides the hydraulic control system for a working machine according to the first, second, third, or fourth aspect that further includes a/the accumulation detector that detects accumulations in the accumulator. A discharge flow of the hybrid pump is controlled to increase or decrease based on either an increase or decrease in the accumulations of the accumulator.

According to this construction, the discharge flow of the hybrid pump can be supplied to the hydraulic cylinders without waste and a shortage.

A sixth aspect of the invention provides the hydraulic control system for a working machine according to the first, second, third, fourth, or fifth aspect that further includes a recovery oil passage. This recovery oil passage supplies the accumulator and a suction side of the hybrid pump with discharged oil pressure from the weight holding side oil chambers of the hydraulic cylinders when the working part descends. When the working part descends, the hybrid pump suctions supplied oil pressure from the recovery oil passage and supplies the oil pressure to weight holding side-opposite oil chambers of the hydraulic cylinders.

According to this construction, the discharged oil pressure from the weight holding side oil chambers of the hydraulic cylinders when the working part descends is accumulated in the accumulator and supplied to the suction side of the hybrid pump so as to be supplied to the weight holding side-opposite oil chambers of the hydraulic cylinders by the hybrid pump. As a result, a positional energy of the working part can be reliably recovered and reused. This thus can contribute greatly to energy savings

A seventh aspect of the invention provides the hydraulic control system for a working machine according to the sixth aspect that further includes a recovery valve. This recovery valve is disposed in the recovery oil passage so as to control a flow of the discharged oil pressure from the weight holding side oil chambers of the hydraulic cylinders.

According to this construction, a descending speed of the working part can be controlled as the recovery valve controls the discharge flow from the weight holding side oil chambers of the hydraulic cylinders. Excellent operability can thus be obtained.

### BRIEF DESCRIPTION OF THE DRAWINGS

Various exemplary aspects of the invention will be described with reference to the drawings, wherein:

FIG. 1 is a side view of a hydraulic shovel;

FIG. 2 is a circuit diagram of a hydraulic control system;

FIG. 3 is a circuit diagram of the hydraulic control system; and

FIG. 4 is a block diagram showing various inputs and outputs of a controller.

### DETAILED DESCRIPTION OF PREFERRED EMBODIMENTS

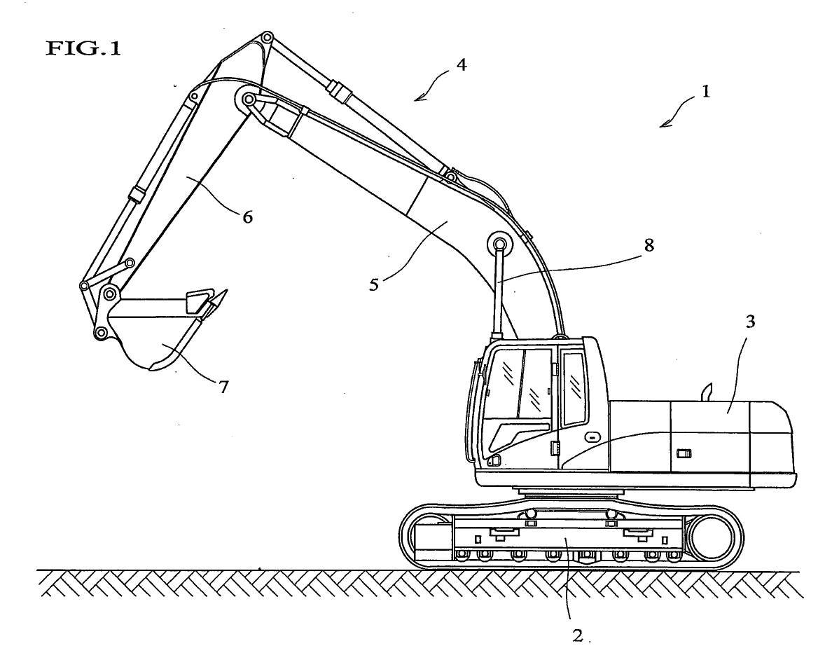

Next, an embodiment of the present invention is described based on the drawings. A hydraulic shovel 1 is an example of a working machine, as shown in FIG. 1. The hydraulic shovel 1 comprises a crawler undercarriage 2; an upper structure 3 supported above the undercarriage 2 so as to freely turn; and a working part 4 fitted to a front of the upper structure 3. The working part 4 comprises a boom 5 having a base end portion supported on the upper structure 3 so as to swing up and down; an arm 6 having an end portion supported on a tip end portion of the boom 5 so as to swing back and forth; and a bucket 7 attached to another end portion of the arm 6.

A pair of right and left boom cylinders 8 (as an example of hydraulic cylinders of the present invention) elongate or contract to make the boom 5 swing upward and downward. The boom cylinders 8 hold a weight of the working part 4 by a pressure in a head-side oil chamber 8a (as an example of weight holding side oil chambers of the present invention). In order to make the boom 5 ascend, the boom cylinders 8 elongate by an oil pressure supply to the head-side oil chamber 8a and an oil discharge from the rod-side oil chambers 8b (as an example of weight holding side-opposite oil chambers of the present invention). In order to make the boom 5 descend, the boom cylinders 8 contract by an oil pressure supply to the rod-side oil chamber 8b and an oil discharge from the head-side oil chamber 8a. A positional energy of the working part 4 increases as the boom 5 ascends. When the boom 5 descends, the positional energy is recovered by a hydraulic control system, which is described below. The recovered energy is utilized when the boom 5 ascends.

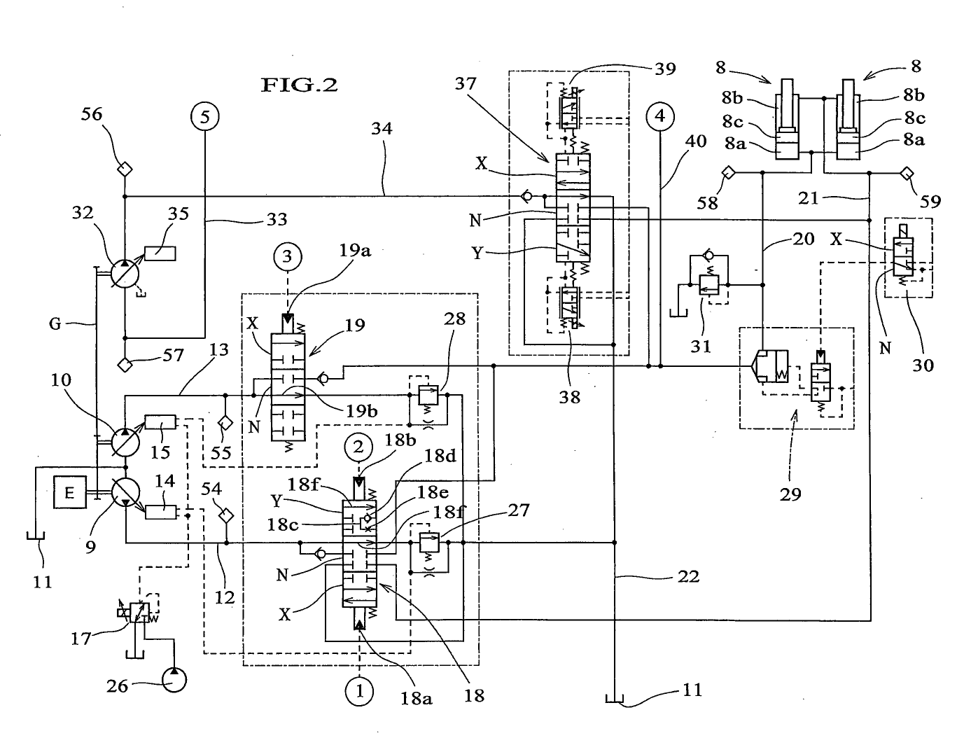

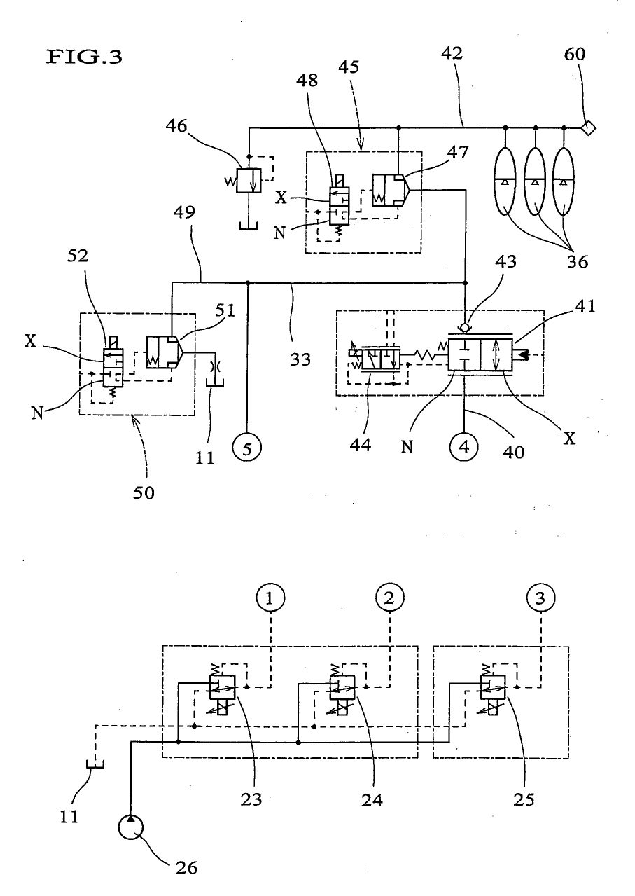

Next, the hydraulic control system is described based on circulation diagrams illustrated in FIGS. 2 and 3. First and second main pumps 9 and 10 are connected to an engine E via a pump drive gear part G. The engine E is mounted on the hydraulic shovel 1. These first and second main pumps 9 and 10 suction operating oil from an oil tank 11 and discharge the oil to first and second pump oil passages 12 and 13. Note that numerals circled in the diagrams of FIGS. 2 and 3 are connector symbols, and corresponding circled numbers are connected to each other.

First and second regulators 14 and 15 control discharge flows of the first and second main pumps 9 and 10. The first and second regulators 14 and 15 operate so as to obtain pump outputs corresponding to a engine rotation speed and a working load by receiving a control signal pressure from a main pump controlling electromagnetic proportional pressure reducing valve 17 that is controlled by a controller 16, which is described later. These first and the second regulators 14 and 15 also perform a constant horsepower control by receiving a discharge pressure from the first and second main pumps 9 and 10. The first and the second regulators 14 and 15 also perform a negative flow control that increases or decreases a pump flow according to movement strokes of spools of first and second control valves 18 and 19, which are described below.

The first and second control valves 18 and 19 are direction-switching valves that are respectively connected to first and second pump oil passages 12 and 13. These first and second control valves 18 and 19 operate to supply the boom cylinders 8 with oil that is discharged from the first and second main pumps 9 and 10.

Note that the first and second main pumps 9 and 10 function as oil pressure supply sources for the boom cylinders 8 as well as such other not-illustrated hydraulic actuators as a traveling motor, a turning motor, an arm cylinder, and a bucket cylinder, all of which are provided in the hydraulic shovel 1. In addition, other hydraulic actuator control valves are also connected to the first and second pump oil passages 12 and 13, a description of which is omitted.

The first control valve 18 comprises a spool valve with ascending side and descending side pilot ports 18a and 18b.

The first control valve 18 is at a neutral position N at which oil is not supplied to and discharged from the boom cylinders 8 when a pilot pressure is not input into the ascending side and descending side pilot ports 18a and 18b.

The spool moves, as a pilot pressure is input into the ascending side pilot port 18a. The spool is now shifted to an ascending side position X at which oil pressure is supplied from the first main pump 9 to the head-side oil chambers 8a of the boom cylinders 8 via a cylinder head side oil passage 20. In addition, at the ascending side position X, oil that is discharged from the rod-side oil chambers 8b to a cylinder rod side oil passage 21 is flowed into the oil tank 11 via a return oil passage 22.

The spool moves to a side opposite to the ascending side position X as a pilot pressure is input into the descending side pilot port 18b. The spool is now shifted to a descending side position Y at which oil that is discharged from the head-side oil chambers 8a to the cylinder head side oil passage 20 is supplied to the rod-side oil chambers 8b from the cylinder rod side oil passage 21 via a recovery valve passage 18c.

Note that the cylinder head side oil passage 20 is connected to the head-side oil chambers 8a so that oil can be supplied to and discharged from the head-side oil chambers 8a of the boom cylinders 8. In addition, the cylinder rod side oil passage 21 is connected to the rod-side oil chambers 8b so that oil can be supplied to and discharged from the rod-side oil chambers 8b of the boom cylinders 8.

The recovering valve passage 18c is provided in the first control valve 18 at the descending side position Y and connects the head-side oil chambers 8a to the rod-side oil chambers 8b of the boom cylinders 8. A check valve 18d is disposed in the recovery valve passage 18c so as to allow an oil flow from the head-side oil chambers 8a to the rod-side oil chambers 8b and obstruct an opposite flow. A restriction 18e is also disposed in the recovery valve passage 18c.

Accordingly, as described above, when the first control valve 18 is at the descending position Y, the discharged oil from the head-side oil chambers 8a is supplied to the rod-side oil chambers 8b via the recovery valve passage 18c. Flow of the oil supply varies according to aperture characteristics of the restriction 18e in the recovery valve passage 18c and differential pressures between the head-side oil chambers 8a and the rod-side oil chambers 8b. The aperture characteristics of the restriction 18e are set according to the spool movement stroke of the first control valve 18.

The second control valve 19 comprises a spool valve with an ascending side pilot port 19a.

The second control valve 19 is at a neutral position N at which oil is not supplied to and discharged from the boom cylinders 8 when a pilot pressure is not input into the ascending side pilot port 19a.

The spool moves as a pilot pressure is input into the ascending side pilot port 19a so as to switch to an ascending side position X at which oil pressure in the second main pump 10 is supplied to the head-side oil chambers 8a of the boom cylinders 8 via the cylinder head side oil passage 20.

Based on control signals from the controller 16, first ascending side, first descending side, and second ascending side electromagnetic proportional pressure reducing valves 23, 24, and 25 output pilot pressures to the ascending side pilot port 18a of the first control valve 18, the descending side pilot port 18b of the first control valve 18, and the ascending side pilot port 19a of the second control valve 19, respectively. Movement strokes of the spools of the first and second control valves 18 and 19 increase or decrease according to an increase or a decrease in pilot pressures that are output from the first ascending side, first descending side, second ascending side electromagnetic proportional pressure reducing valves 23, 24, and 25. Flows of oil that is supplied to and discharged from the boom cylinders 8 can thus be controlled from the first and second control valves 18 and 19.

Note that a pilot pump 26 is a pilot hydraulic pressure source, as shown in FIGS. 2 and 3.

Center bypass valve passages 18f and 19b are formed in the first and second control valves 18 and 19 so as to enable oil pressure in the first and second main pumps 9 and 10 to flow to the oil tank 11 via first and second negative control valves 27 and 28. Opening amounts of the center bypass valve passages 18f and 19b are controlled to be largest when the first and second control valves 18 and 19 are at the neutral position N and to be smaller as the movement strokes of the spools are greater at the ascending side position X.

Independently of the movement stroke of the spool, however, the center bypass passage 18f of the first control valve 18 has a property to maintain a large opening at the descending side position Y. As a result, a passing flow via the center bypass valve passage 18f of the first control valve 18 at the descending side position Y is configured to remain the same as a passing flow when the first control valve 18 is at the neutral position N.

Passing flows of the center bypass valve passages 18f and 19b are input into the first and second regulators 14 and 15 as negative control signals. A so-called negative flow control is performed such that discharge flows of the first and second main pumps 9 and 10 increase, as a passing flow is smaller via the center bypass valve passages 18f and 19b.

As mentioned above, the passing flow remains the same via the center bypass valve passage 18f of the first control valve 18 even if the first control valve 18 switches to the descending side position Y from the neutral position N. A discharge flow of the first main pump 9 is controlled to be minimum when the first control valve 18 is at the descending side position Y by the negative flow control.

A drift reducing valve 29 is disposed in the cylinder head side oil passage 20. A drift reducing valve electromagnetic switching valve 30 is switchable from an OFF position N to an ON position X based on an ON signal from the controller 16.

The drift reducing valve 29 constantly allows an oil flow to the head-side oil chambers 8a of the boom cylinders 8 from the first control valve 18, the second control valve 19, and a third control valve 37 as well, which is described later.

The drift reducing valve 29 obstructs a flow in an opposite direction when the drift reducing valve electromagnetic switching valve 30 is at the OFF position N. The drift reducing valve 29, however, allows an opposite flow only if the drift reducing valve electromagnetic switching valve 30 is at the ON position X.

A relief valve 31 is connected to the cylinder head side oil passage 20. This relief valve 31 limits a maximum pressure of the cylinder head side oil passage 20.

A hybrid pump 32 is also connected to the engine E via the pump drive gear part G. This hybrid pump 32 suctions oil that is supplied from a suction fluid line 33 and discharges the oil to a hybrid pump oil passage 34. A hybrid pump regulator 35 that operates in accordance with a control signal that is output from the controller 16 controls a discharge flow of the hybrid pump 32.

Supplied to the suction oil passage 33, as described later, is oil that is accumulated in an accumulator 36 or discharged from the head-side oil chambers 8a of the boom cylinders 8. The hybrid pump 32 suctions the accumulated oil in the accumulator 36 or the discharged oil from the head-side oil chambers 8a of the boom cylinders 8, then discharges the oil to the hybrid pump oil passage 34. The accumulated oil in the accumulator 36 and the discharged oil from the head-side oil chambers 8a have a high pressure. This pressure yields a driving force to the hybrid pump 32. That is, the hybrid pump 32 is provided with the driving force by the engine E and the accumulated oil in the accumulator 36 or the discharged oil from the head-side oil chambers 8a as well.

A third control valve 37 is connected to the hybrid pump oil passage 34 and supplies the boom cylinders 8 with oil pressure that is discharged from the hybrid pump 32 based on control signals from the controller 16.

The third control valve 37 is a direction switching valve in which a spool moves based on operations of third ascending side and third descending side electric-hydraulic converting valves 38 and 39 into which control signals are input from the controller 16.

The third control valve 37 is at a neutral position N at which an oil supply to and discharge from the boom cylinders 8 is not performed when a control signal is not input to the third ascending side and third descending side electric-hydraulic converting valves 38 and 39.

The spool moves, as an operation signal is input into the third ascending side electric-hydraulic converting valve 38. That is, the spool moves to an ascending side position X at which oil that is discharged from the hybrid pump 32 is supplied to the head-side oil chambers 8a of the boom cylinders 8 via the cylinder head side oil passage 20. In addition, at this ascending side position X, oil that is discharged from the rod-side oil chambers 8b to the cylinder rod side oil passage 21 is flowed to the oil tank 11 via the return oil passage 22.

The spool moves to a side opposite to the ascending side position X as a control signal for an operation is input into the third descending side electric-hydraulic converting valve 39. Now the spool is at a descending side position Y at which oil that is discharged from the hybrid pump 32 is supplied to the rod-side oil chambers 8b of the boom cylinders 8 via the cylinder rod side oil passage 21.

A movement stroke of the spool of the third control valve 37 is controlled to increase or decrease according to signal values of operation signals that are input into the third ascending side and third descending side electric-hydraulic converting valves 38 and 39 from the controller 16. Oil flows are controlled so as to be supplied and discharged to the boom cylinders 8 from the third control valve 37 according to an increasing or decreasing control of the movement stroke of the spool.

A recovery oil passage 40 is branched from the cylinder head side oil passage 20. A recovery valve 41 is disposed in the recovery oil passage 40, which is connected to both an accumulator oil passage 42 and the suction oil passage 33 at a downstream side of the recovery valve 41.

A check valve 43 is also disposed to the recovering oil passage 40 so as to allow an oil flow from the cylinder head side oil passage 20 to the accumulator oil passage 42 and the suction oil passage 33. However, the check valve 43 obstructs a flow in an opposite direction thereof. Accordingly, oil that is discharged to the cylinder head side oil passage 20 from the head-side oil chambers 8a of the boom cylinders 8 can be supplied to the accumulator oil passage 42 and the suction oil passage 33 via the recovery oil passage 40.

The recovery valve 41 is an on-off valve in which a spool moves based on an operation of a recovery electric-hydraulic converting valve 44 into which a control signal is input from the controller 16.

The recovery valve 41 is at a closing position N at which the recovery oil passage 40 is closed when an operation signal is not input into the recovery electric-hydraulic converting valve 44.

The spool moves, as an operation signal is input into the recovery electric-hydraulic converting valve 44 so as to switch to an opening position X at which the recovery oil passage 40 is opened.

A movement stroke of the spool of the recovery valve 41 is controlled to increase or decrease according to signal values of operation signals that are input into the recovery electric-hydraulic converting valve 44 from the controller 16. An increasing or decreasing control of the movement stroke of the spool controls an oil flow from the head-side oil chambers 8a of the boom cylinders 8 to the accumulator oil passage 42 and the suction oil passage 33 via the recovery oil passage 40.

The accumulator oil passage 42 is from the recovery oil passage 40 to the accumulator 36 via an accumulator check valve 45. A relief valve 46 that is connected to the accumulator oil passage 42 limits a maximum pressure of the accumulator oil passage 42.

In this embodiment, the accumulator 36 is bladder-type suitable for accumulating hydraulic energies. However, a type of the accumulator 36 should not be limited as such and may instead be piston-type, for example.

The accumulator check valve 45 comprises a poppet valve 47 and an accumulator check valve electromagnetic switching valve 48 that is switchable from an OFF position N to an ON position X based on an ON signal that is output from the controller 16.

The poppet valve 47 allows an oil flow from the recovery oil passage 40 to the accumulator 36 at whichever the OFF position N or the ON position X the accumulator check valve electromagnetic switching valve 48 is.

The poppet valve 47 obstructs an oil flow from the accumulator 36 to the suction oil passage 33 when the accumulator check valve electromagnetic switching valve 48 is at the OFF position N and allows the flow only when the accumulator check valve electromagnetic switching valve 48 is at the ON position X.

As described above, the flow of oil from the recovery oil passage 40 to the accumulator 36 is allowed at whichever the OFF position N and the ON position X the accumulator check valve electromagnetic switching valve 48 is positioned. However, when the accumulator check valve electromagnetic switching valve 48 is at the ON position X, an accumulator oil passage 42 pressure does not operate in a direction of closing the valve passage of the poppet valve 47. As a result, oil can flow from the recovery oil passage 40 to the accumulator oil passage 42 with substantially no pressure loss.

A discharge oil passage 49 is branched from the suction oil passage 33 to the oil tank 11. A tank check valve 50 is disposed in the discharge oil passage 49.

The tank check valve 50 comprises a poppet valve 51 and a tank check valve electromagnetic switching valve 52 that is switchable from an OFF position N to an ON position X based on an ON signal that is output from the controller 16.

The poppet valve 51 allows an oil flow from the suction oil passage 33 to the oil tank 11 only when the tank check valve electromagnetic switching valve 52 is at the ON position X and obstructs the flow when the tank check valve electromagnetic switching valve 52 is at the OFF position N.

In addition, switching both the accumulator check valve electromagnetic switching valve 48 and the tank check valve electromagnetic switching valve 52 to the ON position X enables the accumulated oil pressure in the accumulator 36 to be released to the oil tank 11, for example, at an end of an operation or for a maintenance of the hydraulic shovel 1.

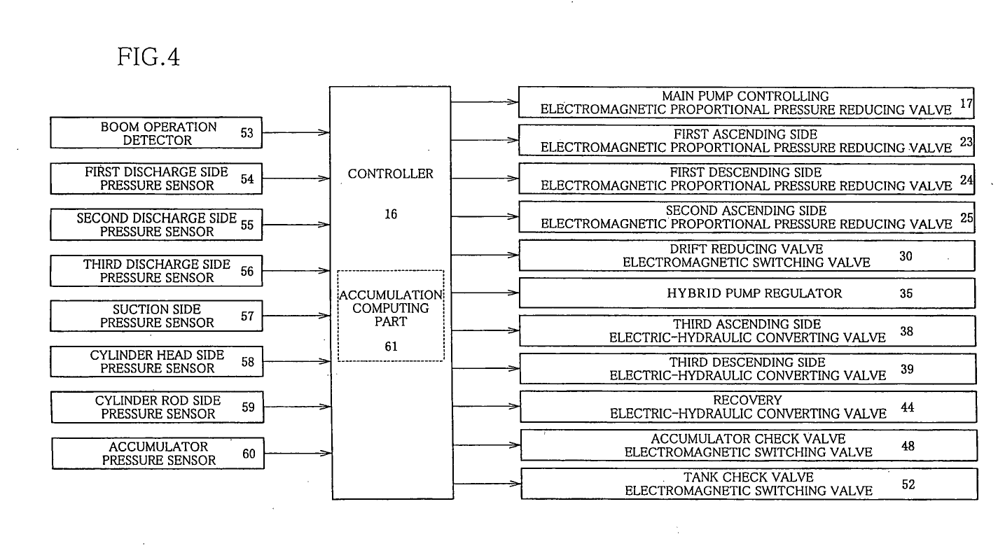

The controller 16 comprises a microcomputer and receives input signals from, for example, a boom operation detector 53 that detects an operating direction and amount of a not-shown boom operation lever; a first discharge side pressure sensor 54 that is connected to the first pump oil passage 12 so as to detect a discharge pressure of the first main pump 9; a second discharge side pressure sensor 55 that is connected to the second discharge side pump oil passage 13 so as to detect a discharge pressure of the second main pump 10; a third discharge side pressure sensor 56 that is connected to the hybrid pump oil passage 34 so as to detect a discharge pressure of the hybrid pump 32; a suction side pressure sensor 57 that is connected to the suction oil passage 33 so as to detect a pressure in the suction side of the hybrid pump 32; a cylinder head side pressure sensor 58 that is connected to the cylinder head side oil passage 20 so as to detect a pressure in the head-side oil chambers 8a of the boom cylinders 8; a cylinder rod side pressure sensor 59 that is connected to the cylinder rod side oil passage 21 so as to detect a pressure in the rod-side oil chambers 8b of the boom cylinders 8; and an accumulator pressure sensor 60 that is connected to the accumulator oil passage 42 so as to detect a pressure in the accumulator 36, all of which are shown in the block diagram of FIG. 4.

Based on these input signals, the controller 16 outputs control signals to, for example, the above-described main pump controlling electromagnetic proportional pressure reducing valve 17; the first ascending side electromagnetic proportional pressure reducing valve 23; the first descending side electromagnetic proportional pressure reducing valve 24; the second ascending side electromagnetic proportional pressure reducing valve 25; the drift reducing valve electromagnetic switching valve 30; the hybrid pump regulator 35; the third ascending side electric-hydraulic converting valve 38; the third descending side electric-hydraulic converting valve 39; the recovery electric-hydraulic converting valve 44; the accumulator check valve electromagnetic switching valve 48; and the tank check valve electromagnetic switching valve 52.

An accumulation computing part 61 is provided at the controller 16 and computes current accumulations of the accumulator 36 in percentage terms (%) based on pressures of the accumulator oil passage 42 that are input from the accumulator pressure sensor 60 (as an example of the accumulation detector of the present embodiment).

An accumulation percentage of the accumulator 36 is computed as 0% when a pressure in the accumulator oil passage 42 is equal to a pre-charged pressure (an accumulation starting set pressure) of the accumulator 36.

An accumulation percentage of the accumulator 36 is computed as 100% when a pressure in the accumulator oil passage 42 is equal to or more than a pressure set in advance under an assumption of a sufficient accumulation in the accumulator 36.

An accumulation percentage of the accumulator 36 increases as a pressure in the accumulator oil passage 42 increases between the pre-charged pressure and the set pressure of the accumulator 36. A temperature correction is applied to this computing of accumulations when necessary.

Next, a description will be given on a control of the controller 16 when the boom operation lever is operated to a boom ascending side. It is when a detection signal of a boom ascending side operation is input from the boom operation detector 53. The control of the controller 16 varies according to accumulations of the accumulator 36 that are computed by the accumulation computing part 61. Such a 100% accumulation as a sufficient accumulation of the accumulator 36 will be first described below.

When the boom operation lever is operated to the boom ascending side under a 100% accumulation of the accumulator 36, the controller 16 outputs a control signal to the main pump controlling electromagnetic proportional pressure reducing valve 17 to obtain a pump output corresponding to an engine rotating speed.

In this case, the controller 16 also outputs a control signal to the second ascending side electromagnetic proportional pressure reducing valve 25 to output a pilot pressure corresponding to an operating amount of the boom operation lever to the ascending side pilot port 19a of the second control valve 19.

Accordingly, the spool in the second control valve 19 switches to the ascending side position X by moving by a stroke corresponding to the operating amount of the boom operation lever. As a result, oil that is discharged from the second main pump 10 flows to the cylinder head side oil passage 20 via the second control valve 19 at the ascending side position X so as to be supplied to the head-side oil chambers 8a of the boom cylinders 8.

Furthermore, the controller 16 outputs a control command to the hybrid pump regulator 35 so that a discharge flow of the hybrid pump 32 can correspond to the operating amount of the boom operation lever.

The controller 16 also outputs an operation signal to the third ascending side electric-hydraulic converting valve 38 with a signal value of the operation signal being corresponding to the operating amount of the boom operation lever.

Accordingly, the spool in the third control valve 37 switches to the ascending side position X by moving by a stroke corresponding to the operating amount of the boom operation lever. As a result, oil that is discharged from the hybrid pump 32 flows to the cylinder head side oil passage 20 via the third control valve 37 at the ascending side position X and flows together with the above-mentioned discharged oil from the second main pump 10 in the cylinder head side oil passage 20 so as to be supplied to the head-side oil chambers 8a of the boom cylinders 8.

On the other hand, oil in the rod-side oil chambers 8b of the boom cylinders 8 is discharged to the oil tank 11 via the third control valve 37 at the ascending side position X.

The controller 16 also outputs an ON signal to the accumulator check valve electromagnetic switching valve 48 to switch to the ON position X. Accordingly, the accumulator check valve 45 allows a flow from the accumulator oil passage 42 to the suction oil passage 33. As a result, oil pressure that is accumulated in the accumulator 36 is supplied to the suction side of the hybrid pump 32 via the suction oil passage 33.

A control signal to output a pilot pressure is not output from the controller 16 to the first ascending side and first descending side electromagnetic proportional pressure reducing valves 23 and 24 when the boom operation lever is operated to the boom ascending side under a 100% accumulation. The first control valve 18 is thus held at the neutral position N. As a result, oil that is discharged from the first main pump 9 is not supplied to the boom cylinders 8. A flow of the first main pump 9 is also controlled to be minimum by a negative flow control.

In addition, an operation signal is not output from the controller 16 to the recovery electric-hydraulic converting valve 44. The recovery valve 41 is thus at the closing position N that closes the recovery oil passage 40. As a result, the above-mentioned supplied oil pressure each from the second control valve 19 and third control valve 37 is supplied to the head-side oil chambers 8a of the boom cylinders 8 without being flowed to the accumulator oil passage 42 and the suction oil passage 33.

Next, a description will be given with respect to a 0% accumulation of the accumulator 36 under which the boom operation lever is operated to the boom ascending side. Controlled in the same manner as the above-described 100% accumulation of the accumulator 36 under which the boom operation lever is operated to the boom ascending side are the main pump controlling electromagnetic proportional pressure reducing valve 17; the second ascending side electromagnetic proportional pressure reducing valve 25; the accumulator check valve electromagnetic switching valve 48; and the recovery electric-hydraulic converting valve 44.

When the boom operation lever is operated to the boom ascending side under a 0% accumulation, the controller 16 outputs a control signal to the first ascending side electromagnetic proportional pressure reducing valve 23 to output a pilot pressure corresponding to an operating amount of the boom operation lever to the ascending side pilot port 18a of the first control valve 18.

Accordingly, the first control valve 18 switches to the ascending side position X as its spool moves by a stroke corresponding to the operating amount of the boom operation lever. As a result, oil that is discharged from the first main pump 9 flows to the cylinder head side oil passage 20 via the first control valve 18 at the ascending side position X and flows together with oil pressure of the second main pump 10 in the cylinder head side oil passage 20 so as to be supplied to the head-side oil chambers 8a of the boom cylinders 8.

On the other hand, oil in the rod-side oil chambers 8b of the boom cylinders 8 is discharged to the oil tank 11 via the first control valve 18 at the ascending side position X.

In addition, the controller 16 outputs a control command to the hybrid pump regulator 35 to zero a discharge flow of the hybrid pump 32, that is, halt an oil pressure supply of the hybrid pump 32. An operation command is not output from the controller 16 to the third ascending side and third descending side electric-hydraulic converting valves 38 and 39. The third control valve 37 is thus held at the neutral position N. As a result, oil pressure is not supplied from the hybrid pump 32 to the head-side oil chambers 8a of the boom cylinders 8.

When the boom operation lever is operated to the boom ascending side between 0% and 100% accumulations of the accumulator 36 (excluding 0% and 100% accumulations), the controller 16 outputs a control signal to the first ascending side electromagnetic proportional pressure reducing valve 23 and the third ascending side electric-hydraulic converting valve 38 as well. The first control valve 18 and the third control valve 37 thus switch to the ascending side positions X.

Accordingly, a control is performed such that oil pressure that is supplied each from the hybrid pump 32 and the first main pump 9 flows together so as to be supplied to the head-side oil chambers 8a of the boom cylinders 8. As the accumulator 36 has fewer accumulations, a discharge flow of the hybrid pump 32 and a movement stroke of the spool of the third control valve 37 are smaller. A movement stroke of the spool of the first control valve 18 is then controlled to increase. Thus, while accumulations are reduced in the accumulator 36, a supply flow is reduced from the hybrid pump 32, and a supply flow is increased from the first main pump 9. In this case, a control is carried out such that a supply flow each from the hybrid pump 32 and the first main pump 9 is added up to a one-pump flow.

Furthermore, the same control is carried out as the above-described 100% accumulation under which the boom operation lever is operated to the boom ascending side with respect to the main pump controlling electromagnetic proportional pressure reducing valve 17; the second ascending side electromagnetic proportional pressure reducing valve 25; the accumulator check valve electromagnetic switching valve 48; and the recovery electric-hydraulic converting valve 44, all of which are between 0% and 100% accumulations.

A one-pump flow that is supplied from the hybrid pump 32 flows together with a one-pump flow that is supplied from the second main pump 10 so as to be supplied to the head-side oil chambers 8a when the boom 5 ascends under a 100% accumulation of the accumulator 36.

Under a 0% accumulation of the accumulator 36, a one-pump flow that is supplied from the first main pump 9, while oil pressure is not supplied from the hybrid pump 32, flows together with a one-pump flow from the second main pump 9 so as to be supplied to the head-side oil chambers 8a.

Between 0% and 100% accumulations of the accumulator 36, a one-pump flow in total by adding a supply flow each from the hybrid pump 32 and the first main pump 9 flows together with a one-pump flow that is supplied from the second main pump 10 so as to be supplied to the head-side oil chambers 8a.

Independently of accumulations of the accumulator 36, a two-pump flow can thus be supplied constantly to the head-side oil chambers 8a when the boom 5 ascends. Accordingly, the boom 5 can be made to ascend at a desired speed according to an operating amount of the boom operation lever even if such ascension opposes a weight load of the working part 4. A differential pressure is small between the suction side and the discharge side because the hybrid pump 32 suctions and discharges high-oil pressure that is accumulated in the accumulator 36. Oil pressure can also be supplied with a required power much less than that of the first and second main pumps 9 and 10.

Next, a description will be given on a control of the controller 16 when the boom operation lever is operated to the boom descending side. It is when a detection signal of a boom descending side operation is input from the boom operation detector 53. The control of the controller 16 remains the same, independently of accumulations of the accumulator 36.

The controller 16 outputs a control signal to the main pump controlling electromagnetic proportional pressure reducing valve 17 to reduce a pump output. In this case, the controller 16 also outputs a control signal to the first descending side electromagnetic proportional pressure reducing valve 24 to output a pilot pressure corresponding to an operating amount of the boom operation lever to the descending side pilot port 18b of the first control valve 18.

Accordingly, the first control valve 18 switches to the descending side position Y as its spool moves by a stroke corresponding to the operating amount of the boom operation lever. As a result, oil that is discharged from the head-side oil chambers 8a of the boom cylinders 8 is supplied to the rod-side oil chambers 8b via the recovery valve passage 18c at the descending side position Y. A discharge flow of the first main pump 9 is controlled to be minimum by a negative flow control because the passing flow remains the same via the center bypass valve passage 18f at the descending side position Y, as described above.

The second control valve 19 is held at the neutral position N when the boom 5 descends. Neither an oil supply nor an oil discharge is performed to or from the boom cylinders 8. A discharge flow of the second main pump 10 is also controlled to be minimum by a negative flow control.

Furthermore, the controller 16 outputs a control command to the hybrid pump regulator 35 so that a discharge flow of the hybrid pump 32 can accord to an operating amount of the boom operation lever. The controller 16 also outputs an operation signal to the third descending side electric-hydraulic converting valve 39 with a signal value of the operation signal being corresponding to an operating amount of the boom operation lever.

Accordingly, the third control valve 37 switches to the descending side position Y as its spool moves by a stroke according to the operating amount of the boom operation lever. As a result, oil that is discharged from the hybrid pump 32 flows to the cylinder rod side oil passage 21 via the third control valve 37 at the descending side position Y so as to be supplied to the rod-side oil chambers 8b of the boom cylinders 8.

In addition, the controller 16 outputs an ON signal to the drift reducing valve electromagnetic switching valve 30 to switch to the ON position X. Accordingly, the drift reducing valve 29 allows an oil discharge from the head-side oil chambers 8a of the boom cylinders 8.

The controller 16 also outputs an operation signal to the recovery electric-hydraulic converting valve 44 with a signal value of the operation signal being corresponding to an operating amount of the boom operation lever.

Accordingly, as its spool moves by a stroke corresponding to the operating amount of the boom operation lever, the recovery valve 41 switches to the open position X at which the recovery oil passage 40 is opened. As a result, oil that is discharged from the head-side oil chambers 8a of the boom cylinders 8 flows to the accumulator oil passage 42 and the suction oil passage 33 via the recovery oil passage 40 so as to be accumulated in the accumulator 36. The discharged oil from the head-side oil chambers 8a is also supplied to the suction side of the hybrid pump 32.

In addition, the controller 16 also outputs an ON signal to the accumulator check valve electromagnetic switching valve 48 to switch to the ON position X. As a result, oil can be supplied from the recovery oil passage 40 to the accumulator oil passage 42 with substantially no pressure loss.

Accordingly, oil pressure from the hybrid pump 32 is supplied to the rod-side oil chambers 8b of the boom cylinders 8 when the boom 5 descends. The hybrid pump 32 suctions high-oil pressure that is discharged from the head-side oil chambers 8a and then discharges the high-oil pressure. A differential pressure is thus small between the suction side and the discharge side. Oil pressure can also be supplied with a required power much less than that of the first main pump 9.

When the boom 5 descends, oil that is discharged from the head-side oil chambers 8a of the boom cylinders 8 has a high pressure because of a positional energy of the working part 4. An amount of the discharged oil from the head-side oil chambers 8a is substantially twice as much as a supply amount to the rod-side oil chambers 8b because of a pressure receiving area that acts on a piston 8c.

The discharged oil from the head-side oil chambers 8a is supplied to the suction side of the hybrid pump 32 and the rod-side oil chambers 8b from the hybrid pump 32, as described above. The discharged oil from the head-side oil chambers 8a is also accumulated in the accumulator 36. Oil pressure that is accumulated in the accumulator 36 is then supplied to the head-side oil chambers 8a from the hybrid pump 32 when the boom 5 ascends, as described above. As a result, the positional energy of the working part 4 can be recovered and reused without waste.

In addition, when the boom 5 descends, part of the discharged oil from the head-side oil chambers 8a is supplied to the rod-side oil chambers 8b via the recovery valve passage 18c of the first control valve 18.

In the present embodiment constructed as described above, the boom cylinders 8 hold the weight of the working part 4 by the pressure of the head-side oil chambers 8a. In order to make the boom 5 ascend, the boom cylinders 8 extend according to an oil pressure supply to the head-side oil chambers 8a and an oil discharge from the rod-side oil chambers 8b. In order to make the boom 5 descend, the boom cylinders 8 contract according to an oil pressure supply to the rod-side oil chambers 8b and an oil discharge from the head-side oil chambers 8a.

The hydraulic control system of the boom cylinders 8 comprises the accumulator 36 that accumulates the discharged oil from the head-side oil chambers 8a of the boom cylinders 8 when the boom 5 descends; the first and second main pumps 9 and 10 that suction and discharge oil from the oil tank 11 so as to supply oil pressure to the boom cylinders 8; and the hybrid pump 32 that suctions and discharges the accumulated oil pressure in the accumulator 36.

When oil is sufficiently accumulated in the accumulator 36 while the boom 5 ascends, then a one-pump supply flow from the second main pump 10 flows together with a one-pump supply flow from the hybrid pump 32 so as to be supplied to the head-side oil chambers 8a.

On the other hand, the first main pump 9 supplies a flow in order to make up for an insufficient supply if an accumulation is insufficient in the accumulator 36 and a supply flow is also insufficient from the hybrid pump 32 to the head-side oil chambers 8a.

When the boom 5 ascends, the one-pump flow from the second main pump 10 thus joins together with the one-pump flow from the hybrid pump 32 and the first main pump 9 for making up for the insufficient supply of the hybrid pump 32. The joined flow is then supplied to the head-side oil chambers 8a of the boom cylinders 8.

Independently of accumulations of the accumulator 36, the boom 5 can thus be made to ascend at a desired speed according to the operating amount of the boom operation lever even if the boom 5 ascends in a direction against the weight load of the working part 4. A differential pressure is small between the suction side and the discharge side because the hybrid pump 32 suctions and discharges the high-pressure accumulated oil in the accumulator 36. The oil pressure can also be supplied with less required power. As a result, a recovered positional energy in the accumulator 36 when the boom 5 descends can be reused when the boom 5 ascends. This can thus contribute greatly to energy savings.

The accumulation computing part 61 of the controller 16 computes the accumulations of the accumulator 36 based on a pressure in the accumulator oil passage 42 being input from the accumulator pressure sensor 60. A supply flow is controlled to increase or decrease from the hybrid pump 32 to the boom cylinders 8 according to an increase or decrease in the accumulations of the accumulator 36 being computed by the accumulation computing part 61. On the other hand, a supply flow is controlled to increase from the first main pump 9 to the boom cylinders 8 as a supply flow decreases from the hybrid pump 32 to the boom cylinders 8.

As a result, each of the supply flow from the hybrid pump 32 and the first main pump 9 making up for the insufficient supply flow of the hybrid pump 32 can be supplied constantly to the boom cylinders 8 in a well-balanced manner in accordance with the accumulations of the accumulator 36. Operability is thus excellent because a smooth operation of the boom 5 can be carried out. In other words, the present embodiment can prevent such a rough operation of the boom 5 at a time of an oil pressure supply shift between the hybrid pump 32 and the first main pump 9 as is often the case with a conventional construction in which when the boom 5 ascends, for example, oil pressure is supplied only from the hybrid pump 32 until the accumulator 36 is empty (a 0% accumulation), then the supply flow is shifted to be supplied from the first main pump 9 when the accumulator 36 is empty.

In addition, the first control valve 18 is provided in order to control a supply flow from the first main pump 9 to the boom cylinders 8. The third control valve 37 is also provided in order to control a supply flow from the hybrid pump 32 to the boom cylinders 8. As a result, the supply flows can be accurately controlled from the first main pump 9 and the hybrid pump 32 to the boom cylinders 8.

Furthermore, a discharge flow of the hybrid pump 32 is controlled to increase or decrease according to an increase or decrease of the accumulations of the accumulator 36 obtained by the accumulation computing part 61. The discharge flow of the hybrid pump 32 can thus be supplied to the boom cylinders 8 without waste or a shortage.

On the other hand, when the boom 5 descends, the discharged oil pressure from the head-side oil chambers 8a of the boom cylinders 8 has a high pressure because of the positional energy of the working part 4. A discharge amount of the discharged oil from the head-side oil chamber 8a is substantially twice as much as a supply amount to the rod-side oil chambers 8b because of the pressure receiving area that acts on the piston 8c. The discharged oil from the head-side oil chambers 8a flows to the accumulator oil passage 42 and the suction oil passage 33 as well via the recovery oil passage 40 and is accumulated in the accumulator 36. The oil discharged from the head-side oil chambers 8a is also supplied to the suction side of the hybrid pump 32.

The hybrid pump 32 suctions the discharged oil from the head-side oil chambers 8a that is supplied from the recovery oil passage 40 and supplies the oil to the rod-side oil chambers 8b of the boom cylinders 8. Because the hybrid pump 32 suctions and discharges the discharged high-oil pressure from the head-side oil chambers 8a, a differential pressure is small between the suction side and the discharge side. The oil pressure can also be supplied with less required power.

Accordingly, the discharged oil pressure from the head-side oil chambers 8a when the boom 5 descends is accumulated in the accumulator 36 and reused when the boom 5 ascends, as described above. The discharged oil pressure from the head-side oil chambers 8a is also supplied to the suction side of the hybrid pump 32 so as to be supplied further to the rod-side oil chambers 8b from the hybrid pump 32. As a result, the positional energy of the working part 4 can be recovered and reused reliably, which greatly contributes to energy savings.

In addition, the recovery valve 41, which controls a flow of the discharged oil from the head-side oil chambers 8a, is disposed in the recovery oil passage 40, through which the discharged oil from the head-side oil chambers 8a can be flowed to the accumulator oil passage 42 and the suction oil passage 33 as well. As a result, because the recovery valve 41 controls the discharged flow from the head-side oil chambers 8a, a descending speed of the boom 5 can be controlled so as to correspond to the operating amount of the boom operation lever. Excellent operability can thus be obtained.

The present invention is not limited to the above-described embodiment, which exemplifies the hydraulic control system for boom cylinders of a hydraulic shovel. The present embodiment can also be carried out in hydraulic control systems for various hydraulic cylinders that make working parts ascend and descend.

The second main pump is provided in the above-described embodiment, along with the hybrid pump and the first main pump, all of which supply oil pressure to the hydraulic cylinders. Accordingly, the oil pressure can be supplied by a two-pump flow when the working part ascends in a direction against the weight load. The present embodiment may also be carried out even if the second main pump is not provided, however.

The present invention is useful for a hydraulic circuit system for a working machine with a working part that ascends and descends in which a positional energy of the working part can be recovered and reused. Discharged oil from a regular hydraulic cylinder when the working part descends can be accumulated in an accumulator without any auxiliary hydraulic cylinder being provided. The hydraulic pressure can be supplied independently of accumulations of the accumulator because the accumulated oil pressure in the accumulator can be supplied from the hybrid pump or first main pump to the hydraulic cylinders, when the working part ascends. In addition, a differential pressure is small between the suction side and the discharge side because of the hybrid pump. The oil pressure supply can be performed with less required power. As a result, a positional energy recovered in the accumulator when the working part descends can be reused when the working part ascends. A great energy-saving contribution can thus be achieved.

1. A hydraulic control system in a working machine, comprising:
hydraulic cylinders that make a working part ascend and descend;
a first main pump that suctions oil from an oil tank and discharges the oil;
an accumulator that accumulates oil discharged from weight holding side oil chambers of the hydraulic cylinders when the working part descends; and
a hybrid pump that suctions accumulated oil pressure in the accumulator and discharges the oil pressure, wherein:
when the working part ascends, discharged oil from the hybrid pump is supplied to the weight holding side oil chambers of the hydraulic cylinders, and
when an insufficient supply flow from the hybrid pump to the hydraulic cylinders exists, a complementary flow corresponding to the insufficient supply flow is supplied from the first main pump to the weight holding side oil chambers of the hydraulic cylinders.

2. The hydraulic control system in the working machine according to claim 1, further comprising:
a second main pump that suctions oil from the oil tank and discharges the oil, wherein:
when the working part ascends, a supply flow from the second main pump joins together with a supply flow from each of the hybrid pump and the first main pump so as to be supplied to the weight holding side oil chambers of the hydraulic cylinders.

3. The hydraulic control system in the working machine according to claim 1, further comprising:
an accumulation detector that detects accumulations in the accumulator, wherein:
a supply flow is controlled to either increase or decrease from the hybrid pump to the hydraulic cylinders in accordance with an increase or a decrease in the accumulations of the accumulator, and
a supply flow is controlled to increase from the first main pump to the hydraulic cylinders as the supply flow decreases from the hybrid pump to the hydraulic cylinders.

4. The hydraulic control system in the working machine according to claim 1, further comprising:
a first control valve that controls a supply flow from the first main pump to the hydraulic cylinders; and
a second control valve that controls a supply flow from the hybrid pump to the hydraulic cylinders.

5. The hydraulic control system in the working machine according to claim 1, further comprising:
an accumulation detector that detects accumulations in the accumulator, wherein:
a discharge flow of the hybrid pump is controlled to either increase or decrease in accordance with an increase or a decrease in the accumulations of the accumulator.

6. The hydraulic control system in the working machine according to claim 1, further comprising:
a recovery oil passage that supplies the accumulator and a suction side of the hybrid pump with discharged oil pressure from the weight holding side oil chambers of the hydraulic cylinders when the working part descends, wherein:
when the working part descends, the hybrid pump suctions supplied oil pressure from the recovery oil passage so as to supply the oil pressure to weight holding side-opposite oil chambers.

7. The hydraulic control system in the working machine according to claim 6, wherein a recovery valve is disposed in the recovery oil passage so as to control a flow of the discharged oil pressure from the weight holding side oil chambers of the hydraulic cylinders.
